(19) United States
(12) Patent Application Publication
(10) Pub. No.: US 2024/0356622 A1
(43) Pub. Date: Oct. 24, 2024

(54) METHODS AND DEVICES FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/681,325

(22) PCT Filed: Aug. 6, 2021
(86) PCT No.: PCT/CN2021/111353

§ 371 Date: Feb. 5, 2024

(51) Int. Cl. H04B 7/06; H04W 74/0833

(52) U.S. Cl. CPC H04B 7/06964; H04W 74/0833

(57) ABSTRACT

Embodiments of the present disclosure relate to methods, devices and computer storage media for communication. A method comprises receiving, at a terminal device, from a network device, a first set of reference signals (RSs) and a second set of RSs; receiving, one or more configurations of a first timer and a second timer; performing a beam failure detection related to a first procedure based on the first set and the first timer, performing a beam failure detection related to a second procedure based on the second set and the second timer; and performing a third procedure based on a first condition and/or a first parameter related to at least one of the first procedure and the second procedure.

### TECHNICAL FIELD

Embodiments of the present disclosure generally relate to the field of telecommunication, and in particular, to methods, devices and computer storage media for communication.

### BACKGROUND

Recently, enhancements on the support for multi-transmission and reception point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has been proposed to identify and specify quasi co-location (QCL)/transmission configuration indicator (TCI) related enhancements to enable inter-cell multi-TRP operations, assuming multi-downlink control information (multi-DCI) based multi-PDSCH reception. It has also been proposed to evaluate and, if needed, specify beam management related enhancements for simultaneous multi-TRP transmission with multi-panel reception.

### SUMMARY

In general, example embodiments of the present disclosure provide methods, devices and computer storage media for communication.

In a first aspect, there is provided a method of communication. The method comprises receiving, at a terminal device, from a network device, a first set of reference signals (RSs) and a second set of RSs; receiving, one or more configurations of a first timer and a second timer; performing a beam failure detection related to the a first procedure based on the first set and the first timer; performing a beam failure detection related to the a second procedure based on the second set and the second timer; and performing a third procedure based on a first condition and/or a first parameter related to at least one of the first procedure and the second procedure

In a second aspect, there is provided a method of communication. The method comprises transmitting, at a network device, to a terminal device, a first set of reference signals (RSs) for a first procedure and a second set of RSs for a second procedure; transmitting, one or more configurations of a first timer and a second timer for the first procedure and the second procedure; and receiving, from the terminal device, a beam failure recovery request or a random access preamble.

In a third aspect, there is provided a terminal device. The terminal device comprises circuitry configured to perform the method according to the above first aspect of the present disclosure.

In a fourth aspect, there is provided a network device. The network device comprises circuitry configured to perform the method according to the above second aspect of the present disclosure.

In a fifth aspect, there is provided a computer program product comprising machine-executable instructions. The machine-executable instructions, when being executed, cause a machine to perform the method according to the above first or second aspect of the present disclosure.

In a sixth aspect, there is provided a computer readable medium having instructions stored thereon. The instructions, when executed on at least one processor, causing the at least one processor to perform the method according to the above first or second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example signaling chart in accordance with some embodiments of the present disclosure;

FIGS. 3A-3C illustrate examples of embodiments of the present disclosure;

FIGS. 4A-4B illustrate examples of embodiments of the present disclosure;

FIG. 5 illustrates an example of embodiments of the present disclosure;

FIG. 6A-6D illustrate examples of embodiments of the present disclosure;

FIG. 7A-7B illustrate examples of embodiments of the present disclosure;

FIG. 8 illustrates a flowchart of an example method in accordance with some embodiments of the present disclosure;

FIG. 9 illustrates a flowchart of an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As described above, it has been proposed to evaluate and, if needed, specify beam management related enhancements for simultaneous multi-TRP transmission with multi-panel reception. However, how to solve multi-TRP based beam failure recovery is a big challenge for a reliable communication.

Embodiments of the present disclosure provide a solution to solve the above problem and/or one or more of other potential problems. According to this solution, in response to a beam failure being detected by a terminal device on a cell in a group of cells, the terminal device may transmit a beam failure recovery request (BFRQ) to a network device, where the BFRQ comprises TRP information related to the beam failure detected on the cell. For example, the TRP information may indicate at least one of the following: the number of TRPs related to the beam failure detected on the cell, a TRP index related to the beam failure detected on the cell, whether a new candidate beam is identified on a failed TRP, information about the new candidate beam if it is identified on the failed TRP, and so on. In this way, this solution can support multi-TRP based BFRQ.

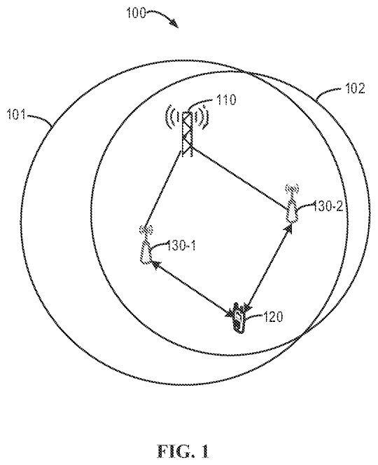

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

In some scenarios, carrier aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 120 is associated to the MCG or the SCG, respectively. In other cases than the Dual Connectivity operation, the term “SpCell” may also refer to the PCell.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

There are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NACK of the PDSCH scheduled by the DCI carrying the beam indication can be used as an ACK also for the DCI.

It is also proposed to support activation of one or more TCI states via medium access control (MAC) control element (CE) analogous to Release. 15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the TDRA field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Format1-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1’s; MCS=all ‘1’s; NDI=0; and set to all ‘0’s for FDRA Type 0, or all ‘1’s for FDRA Type 1, or all ‘0’s for dynamicSwitch (same as in Table 10.2-4 of TS38.213).

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats; carrier indicator; bandwidth part indicator; time domain resource assignment (TDRA); downlink assignment index (if configured); transmit power control (TPC) command for scheduled PUCCH; PUCCH resource indicator; PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot that is at least X ms or Y symbols after the last symbol of the acknowledgment of the joint or separate DL/UL beam indication.

As shown in FIG. 1, for example, the network device 110 may communicate with the terminal device 120 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP. As described above, the network device 110 may provide a group of cells to serve the terminal device 120. In some embodiments, the group of cells may be divided into a first subset of cells associated with the first TRP 130-1 and a second subset of cells associated with the second TRP 130-2. For example, the first subset of cells and the second subset of cells may include one or more overlapping cells or may not overlap each other.

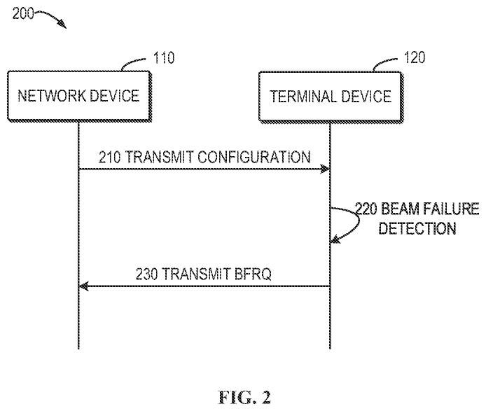

FIG. 2 illustrates a singling chart 200 in accordance with embodiments of the present disclosure. As shown in FIG. 2, the network device 110 may transmit 210 a configuration to the terminal device 120. In some embodiments, the configuration may indicate that each of a group of cells serving the terminal device 120 is associated with at least one of TRPs 130 coupled with the network device 110. For example, the configuration may be transmitted from the network device 110 to the terminal device 120 via at least one of Radio Resource Control (RRC) signaling, Medium Access Control (MAC) control element (CE) or Downlink Control Information (DCI). The terminal device 120 may perform 220 beam failure detection. In response to a beam failure being detected on a cell in the group of cells, the terminal device 120 may transmit a BFRQ to the network device 110 based on the configuration. In some embodiments, the BFRQ may comprise TRP information related to the beam failure detected on the cell.

In some embodiments, the terminal device 120 may be configured with M TRPs in a bandwidth part (BWP) for a cell, where M is a positive integer. For example, 1≤M≤4. For another example, M=2. In some embodiments, each TRP in the M TRPs may be represented by or associated with at least one of the following: a control resource set (CORESET) pool index; a CORESET group identifier (ID); a group of CORESETs; a CORESET set ID; a set of CORESETs; a SRS resource set; a SRS resource set ID; a TCI state; a group of TCI states; an ID of a set of reference signals (RSs) for beam failure detection; an ID of a set of RSs for new/candidate beam identification; spatial relation information; a group of spatial relation information; a set of QCL parameters; a group of RSs for beam failure detection; a group of RSs for new/candidate beam identification; and so on. In the example as shown in FIG. 1B, M=2. In some embodiments, the first TRP 130-1 may be represented by or associated with at least one of the following: a first CORESET pool index (for example, with a value of 0. For another example, CORESET(s) without configuration of the parameter “CORESET pool index”); a first CORESET group/set/subset ID; a first group/set/subset of CORESETs (For example, CORESET(s) configured with the first CORESET pool index or the first CORESET group/set/subset ID. For another example, CORESET(s) not configured with the parameter “CORESET pool index” or the parameter “CORESET group/set/subset ID”); a first SRS resource set; a first SRS resource set ID; a first TCI state; a first group of TCI states; an ID of a first set of reference signals (RSs) for beam failure detection; the first set of reference signals (RSs) for beam failure detection; an ID of a first set of RSs for new/candidate beam identification; the first set of RSs for new/candidate beam identification; first spatial relation information; a first group of spatial relation information; a first set of QCL parameters: a first group of RSs for beam failure detection; a first group of RSs for new/candidate beam identification; and so on. The second TRP 130-2 may be represented by at least one of the following: a second CORESET pool index (for example, with a value of 1); a second CORESET group/set/subset ID: a second group/set/subset of CORESETs (For example, CORESET(s) configured with the second CORESET pool index or the second CORESET group/set/subset ID.); a second SRS resource set; a second SRS resource set ID; a second TCI state; a second group of TCI states; an ID of a second set of reference signals (RSs) for beam failure detection; the second set of reference signals (RSs) for beam failure detection; an ID of a second set of RSs for new/candidate beam identification; the second set of RSs for new/candidate beam identification; second spatial relation information; a second group of spatial relation information; a second set of QCL parameters; a second group of RSs for beam failure detection; a second group of RSs for new/candidate beam identification; and so on.

In some embodiments, the terminal device 120 may be configured with a first TRP (for example, the first TRP 130-1) and a second TRP (for example, the second TRP 130-2) in a BWP for a cell.

In some embodiments, the terminal device 120 may be configured with a first procedure, a second procedure and a third procedure for the cell and/or for the BWP. For example, the first procedure is a TRP-specific beam failure detection and recovery procedure related to the first TRP. For another example, the second procedure is a TRP-specific beam failure detection and recovery procedure related to the second TRP. For example, the third procedure is a cell specific beam failure detection and recovery procedure or a random access procedure related to the BWP and/or the cell. It needs to be designed the relationship between the first procedure, the second procedure and the third procedure. For example, when a beam failure recovery is triggered for the first TRP or the second TRP, whether to increase a counter for beam failure detection related to the third procedure.

In some embodiments, the terminal device 120 may receive a configuration or an activation command, and the configuration or the activation command is used to map up to 8 combinations of one or two TCI states to a set of TCI codepoints. For example, the number of TCI codepoints in the set of TCI may be at least one of {1, 2, 3, 4, 5, 6, 7, 8, 9, 10, 11, 12, 13, 14, 15, 16}. For example, the set of TCI codepoints are indicated in a DCI field “transmission configuration indication”. In some embodiments, if at least one TCI codepoint indicates two TCI states (for example, a first TCI state and a second TCI state), the terminal device 120 may be served with two TRPs (for example, a first TRP and a second TRP). For example, the first TCI state is associated with the first TRP, and the second TCI state is associated with the second TRP.

In the following, the terms “TRP”. “CORESET pool index”, “CORESET group/set/subset ID”, “group/set/subset of CORESETs”, “SRS resource set”. “SRS resource set ID”, “TCI state”, “group of TCI states”, “ID of a set of RSs for beam failure detection”, “ID of a set of RSs for new/candidate beam identification”, “spatial relation information”, “group of spatial relation information”, “set of QCL parameters”, “group of RSs for beam failure detection” and “group of RSs for new/candidate beam identification” can be used interchangeably. The terms “first TRP”, “first CORESET pool index”, “first CORESET group/set/subset ID”, “first group/set/subset of CORESETs”, “first SRS resource set”, “first SRS resource set ID”, “first TCI state”, “first TCI state of two TCI states corresponding to a TCI codepoint”, “first group of TCI states”, “ID of a first set of RSs for beam failure detection”, “first set of RSs for beam failure detection”, “ID of a first set of RSs for new/candidate beam identification”, “first set of RSs for new/candidate beam identification”, “first spatial relation information”, “first group of spatial relation information”, “first set of QCL parameters”, “first group of RSs for beam failure detection” and “first group of RSs for new/candidate beam identification” can be used interchangeably. The terms “second TRP”, “second CORESET pool index”, “second CORESET group/set/subset ID”, “second group/set/subset of CORESETs”, “second SRS resource set”. “second SRS resource set ID”, “second TCI state”, “secondTCI state of two TCI states corresponding to a TCI codepoint”, “second group of TCI states”, “ID of a second set of RSs for beam failure detection”, “second set of RSs for beam failure detection”; “ID of a second set of RSs for new/candidate beam identification”, “second set of RSs for new/candidate beam identification”, “second spatial relation information”, “second group of spatial relation information”, “second set of QCL parameters”, “second group of RSs for beam failure detection” and “second group of RSs for new/candidate beam identification” can be used interchangeably. The terms “PUSCH” and “PUSCH MAC CE” can be used interchangeably.

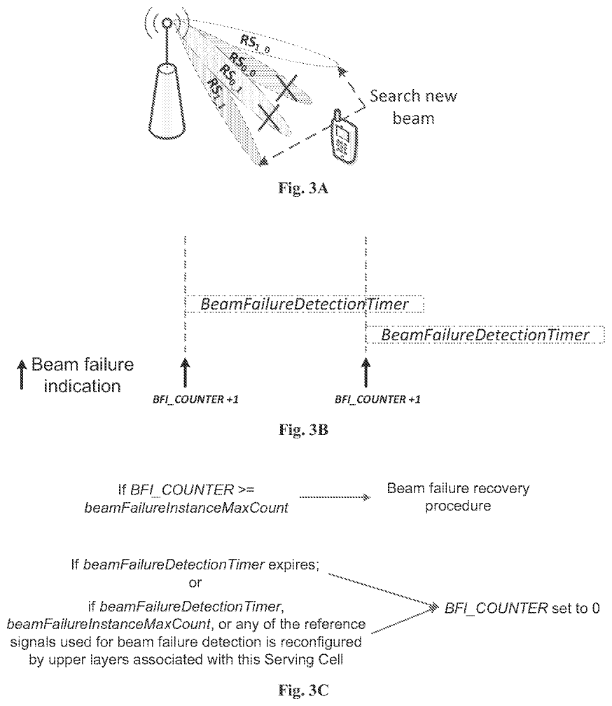

FIGS. 3A-3C illustrate examples in accordance with some embodiments of the present disclosure.

As shown in FIG. 3A, the terminal device 120 may be configured with a set of RSs for beam failure detection (RS_{0_0} and RS_{0_1}), and a set of RSs for new/candidate beam identification (RS_{1_0} and RS_{1_1}). In case of RS_{0_0} and RS_{0_1} failed, the terminal device may search new beam based on RS_{1_0} and RS_{1_1}.

As shown in FIG. 3B, the terminal device 120 may be configured with a timer (BeamFailureDetectionTimer), and if a beam failure instance indication is indicated or received from the lower layers of the terminal device, the value of BFI_COUNTER is increased by 1, and the timer may be started or restarted. For example, if the timer doesn't expire, and if a beam failure instance indication is indicated or received from the lower layers of the terminal device, the value of BFI_COUNTER is increased by 1, and the timer may be started or restarted. For another example, if the timer expires, the value of BFI_COUNTER is set to 0.

As shown in FIG. 3C, if the value of BFI_COUNTER is larger than or equal to a maximum value (beamFailureInstanceMaxCount), the beam failure recovery procedure is triggered. For example, if beam Failure Detection Timer expires if or beamFailureDetectionTimer, beamFailureInstanceMaxCount, or any of the RSs used for beam failure detection is reconfigured, the value of BFI_COUNTER is set to 0.

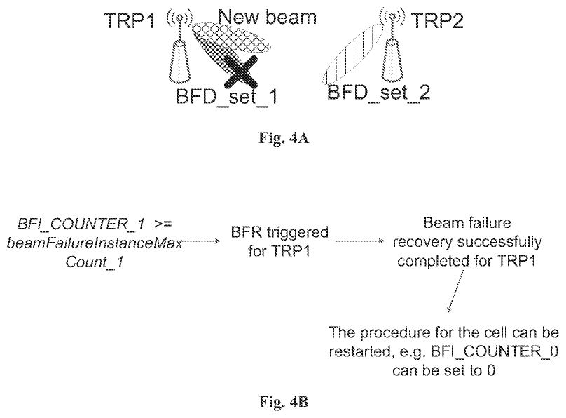

FIGS. 4A-4B illustrate examples in accordance with some embodiments of the present disclosure.

As shown in FIG. 4A, the terminal device 120 may be configured with a first TRP (TRP1) and a second TRP (TRP2) for communication with the network device 110. For example, a first set of RSs for beam failure detection (BFD_set_1) may be configured for beam failure detection. For example, for the first TRP. For another example, a second set of RSs for beam failure detection (BFD_set_2) may be configured for beam failure detection. For example, for the second TRP. For example, if beam failure is declared based on the BFD_set_1, the terminal device 120 may search or select a new beam. For example, based on a set of RSs for new/candidate beam identification, wherein the new/candidate beam identification may be configured. For example, associated with the first TRP.

As shown in FIG. 4B, if the value of BFI_COUNTER_1 is larger than or equal to the first maximum value (for example, beamFailureInstanceMaxCount_1), the beam failure recovery procedure is triggered. For example, related to the first procedure. For example, if the beam failure recovery is successfully completed related to the first procedure, the third procedure may be restarted or the value of the third counter (e.g. BFI_COUNTER_0) may be set to 0.

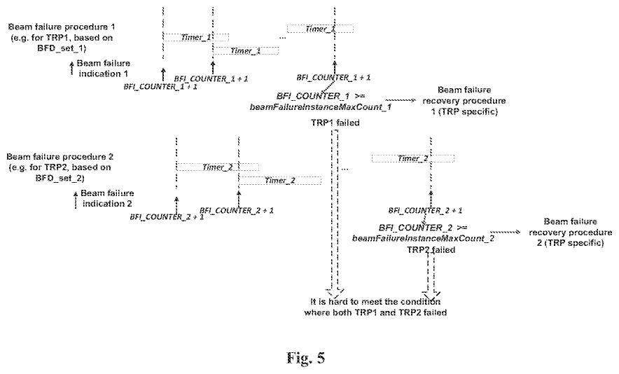

FIG. 5 illustrates an example in accordance with some embodiments of the present disclosure.

As shown in FIG. 5, the terminal device 120 may be configured with a first timer (Time_1) in a first procedure (beam failure procedure 1). For example, the first procedure is for the first TRP (TRP1). And the beam failure detection is based on the first set of RSs for beam failure detection (BFD_set_1). For example, if a beam failure indication 1 is received from lower layers of the terminal device, the value of a first counter (BFI_COUNTER_1) is increased by 1. For example, if BFI_COUNTER_1 is larger than or equal to the first maximum value (beamFailureInstanceMaxCount_1), a BFR is triggered for the first procedure. For example, the first TRP (TRP1) is failed. And the terminal device 120 may be configured with a second timer (Time_2) in a second procedure (beam failure procedure 2). For example, the second procedure is for the second TRP (TRP2). And the beam failure detection is based on the second set of RSs for beam failure detection (BFD_set_2). For example, if a beam failure indication 2 is received from lower layers of the terminal device, the value of a second counter (BFI_COUNTER_2) is increased by 1. For example, if BFI_COUNTER_2 is larger than or equal to the second maximum value (beamFailureInstanceMaxCount_2), a BFR is triggered for the second procedure. For example, the second TRP (TRP2) is failed. For example, it may be hard to meet the condition that both the first TRP and the second TRP are failed simultaneously or within a short duration. For example, it needs to be designed how to trigger the third procedure to make full usage of the cell specific BFR.

In some embodiments, the terminal device 120 may be configured with a first procedure. For example, the first procedure is a procedure for beam failure detection and recovery. For another example, the first procedure is a TRP specific beam failure detection and recovery procedure. For another example, the first procedure is related to the first TRP. In some embodiments, the terminal device 120 may be configured with a second procedure. For example, the second procedure is a procedure for beam failure detection and recovery. For another example, the second procedure is a TRP specific beam failure detection and recovery procedure. For another example, the second procedure is related to the second TRP. In some embodiments, the terminal device 120 may be configured with a third procedure. For example, the third procedure is a procedure for beam failure detection and recovery. For another example, the third procedure is a cell specific or random access channel (RACH) based beam failure detection and recovery procedure. For another example, the third procedure is related to the cell. For example, the first TRP and the second TRP are configured in a BWP in the cell. In some embodiments, the first procedure, the second procedure and the third procedure are performed on the same BWP and/or on the same cell.

In some embodiments, the terminal device 120 may receive at least one configuration, wherein the at least one configuration may include at least one of: a first maximum value (For example, the first maximum value may be for beam failure instance count. For another the maximum example, first value may be beamFailureInstanceMaxCount_1), a first timer (For example, the first timer may be a timer for beam failure detection. For another example, the first timer may be beamFailureDetectionTimer_1), the first set of RSs for beam failure detection, the first set of RSs for new/candidate beam identification (For example, candidateBeamRSList_1), and a first threshold (For example, the first threshold may be an RSRP threshold. For another example, the first threshold may be rsrp_Threshold_1). In some embodiments, the at least one configuration may be for the first procedure.

In some embodiments, the terminal device 120 may receive at least one configuration, wherein the at least one configuration may include at least one of: a second maximum value (For example, the second maximum value may be for beam failure instance count. For another example, the second maximum value may be beamFailureInstanceMaxCount_2), a second timer (For example, the second timer may be a timer for beam failure detection. For another example, the second timer may be beamFailureDetectionTimer_2), the second set of RSs for new/candidate beam identification (For example, candidateBeamRSList_2), and a second threshold (For example, the second threshold may be an RSRP threshold. For another example, the second threshold may be rsrp_Threshold_2). In some embodiments, the at least one configuration may be for the second procedure.

In some embodiments, the terminal device 120 may receive at least one configuration, wherein the at least one configuration may include at least one of: a third maximum value (For example, the third maximum value may be for beam failure instance count. For another example, the third maximum value may be beamFailureInstanceMaxCount_0), a third timer (For example, the third timer may be a timer for beam failure detection. For another example, the third timer may be beamFailureDetectionTimer_0), a third set of RSs for new/candidate beam identification (For example, candidateBeamRSList_3), and a third threshold (For example, the third threshold may be an RSRP threshold. For another example, the third threshold may be rsrp_Threshold_0). In some embodiments, the at least one configuration may be for the third procedure.

In some embodiments, the terminal device 120 may receive a first set of RSs for beam failure detection and a second set of RSs for beam failure detection. In some embodiments, the RS may be a CSI-RS. In some embodiments, the terminal device 120 may receive a configuration for the first set of RSs. In some embodiments, the terminal device 120 may determine the first set of RSs based on one or more RSs indicated by one or more TCI states for the first set of CORESETs. In some embodiments, the terminal device 120 may receive a configuration for the second set of RSs. In some embodiments, the terminal device 120 may determine the second set of RSs based on one or more RSs indicated by one or more TCI states for the second set of CORESETs. In some embodiments, the terminal device 120 may receive one or more configurations of the first set of CORESETs and the second set of CORESETs for the BWP in the cell. In some embodiments, the first set of CORESETs may be associated with the first TRP. In some embodiments, the second set of CORESETs may be associated with the second TRP.

In some embodiments, the terminal device 120 may perform a beam failure detection related to the first procedure based on the first set of RSs and the first timer. In some embodiments, the terminal device 120 may perform a beam failure detection related to the second procedure based on the second set of RSs and the second timer.

In some embodiments, the terminal device 120 may perform the third procedure based on a first condition and/or a first parameter related to at least one of the first procedure and the second procedure.

In some embodiments, there may be a first counter for beam failure detection related to the first procedure, wherein the first counter may be increased by 1 in case of a beam failure instance indication related to the first procedure. For example, the beam failure instance indication may be received at higher layers and from lower layers of the terminal device 120. For another example, the beam failure instance indication may be based on the first set of RSs. In some embodiments, there may be a second counter for beam failure detection related to the first procedure, wherein the second counter may be increased by 1 in case of a beam failure instance indication related to the second procedure. For example, the beam failure instance indication may be received at higher layers and from lower layers of the terminal device 120. For another example, the beam failure instance indication may be based on the second set of RSs.

In some embodiments, the terminal device 120 may perform a beam failure detection related to the third procedure based on a third set of RSs and a third timer.

In some embodiments, the RS may be a CSI-RS. In some embodiments, the terminal device 120 may receive a configuration of the third set of RSs from the network device. In some embodiments, the terminal device 120 may determine the third set of RSs based on the first set of RSs and the second set of RSs. In some embodiments, the third set of RSs may be a union set of the first set of RSs and the second set of RSs. In some embodiments, the third set of RSs may comprise at least one RS from the first set of RSs and at least one RS from the second set of RSs. In some embodiments, at least one RS from the first set of RSs and/or at least one RS from the second set of RSs may not be included in the third set of RSs. In some embodiments, the terminal device 120 may determine the third set of RSs based on one or more RSs indicated by one or more TCI states for the first set of CORESETs and/or one or more RSs indicated by one or more TCI states for the second set of CORESETs.

In some embodiments, the third timer may be determined based on the first timer and the second timer. In some embodiments, the value of the third timer may be the larger or maximum value between the value of the first timer and the value of the second timer. For example, the third timer may be max(the first timer, the second timer). For another example, the value of the third timer may be max(the value of the first timer, the value of the second timer). For another example, the value of the third timer may be same with the value of the first timer, if the value of the first timer is larger than and/or equal to the value of the second timer. For another example, the value of the third timer may be same with the value of the second timer, if the value of the first timer is less than and/or equal to the value of the second timer. For another example, the third timer may be same with the first timer, if the value of the first timer is larger than and/or equal to the value of the second timer. For another example, the third timer may be same with the second timer, if the value of the first timer is less than and/or equal to the value of the second timer. In some embodiments, the terminal device 120 may receive a configuration of the third timer from the network device.

In some embodiments, there may be a third counter for beam failure detection related to the third procedure. In some embodiments, the third counter may be increased by 1 in case of a beam failure instance indication related to the third procedure. For example, the beam failure instance indication may be received at higher layers and from lower layers of the terminal device 120. For another example, the beam failure instance indication may be based on a third set of RSs. In some embodiments, the third counter may be increased by 1 based on at least one of the first counter, the second counter, the first timer, the second timer, the third timer and a first duration.

In some embodiments, the terminal device 120 may set the third counter to 0 based on the first condition. In some embodiments, the first condition may comprise at least one of: a beam failure recovery (BFR) related to the first procedure is triggered; a BFR related to the second procedure is triggered; the first counter for beam failure detection related to the first procedure is larger than or equal to the first maximum value; the second counter for beam failure detection related to the second procedure is larger than or equal to the second maximum value; the first timer expires; the second timer expires; the first timer is reconfigured; the second timer is reconfigured; the first maximum value is reconfigured; the second maximum value is reconfigured; any of the RS in the first set of RSs is reconfigured or changed or replaced or updated; any of the RS in the second set of RSs is reconfigured or changed or replaced or updated; a TCI state for any of the RS in the first set of RSs is reconfigured or changed or updated; a TCI state for any of the RS in the second set of RSs is reconfigured or changed or updated; a beam failure recovery related to the first procedure is successfully completed; a beam failure recovery related to the second procedure is successfully completed; the first counter for beam failure detection related to the first procedure is set to 0; the second counter for beam failure detection related to the second procedure is set to 0; the cell is deactivated; the first TRP is deactivated; the second TRP is deactivated; all triggered BFRs related to the first procedure are canceled; and all triggered BFRs related to the second procedure are canceled.

In some embodiments, the terminal device 120 may perform a beam failure detection related to the third procedure based on the first set of RSs and/or the first timer in case of a second condition is satisfied. In some embodiments, the terminal device 120 may perform a beam failure detection related to the third procedure based on the third set of RSs and/or the third timer in case of the second condition is not satisfied.

In some embodiments, the second condition may comprise at least one of: a BFR related to the second procedure is triggered; a BFR related to the second procedure is triggered and a BFR related to the first procedure is not triggered; a duration between a BFR related to the second procedure is triggered and the BFR related to the second procedure is successfully completed; a duration starting from a BFR related to the second procedure is triggered to the BFR related to the second procedure is successfully completed; a duration starting from the BFR related to the second procedure is triggered to a BFR related to the first procedure or related to the third procedure is triggered; and a duration between the BFR related to the second procedure is triggered and a BFR related to the first procedure or related to the third procedure is triggered.

In some embodiments, the value of the third timer for beam failure detection related to the third procedure may be determined based on the first counter for beam failure detection related to the first procedure, the second counter for beam failure detection related to the second procedure and the third timer.

In some embodiments, the terminal device 120 may start or restart the third timer, in case of a beam failure instance indication related to the first procedure is indicated or received. For example from the lower layers of the terminal device. In some embodiments, the beam failure instance indication may be based on the first set of RSs. In some embodiments, the terminal device 120 may start or restart the third timer, in case of the first counter is increased by 1. In some embodiments, the terminal device 120 may increase the third counter by 1, within a duration before the third timer expires (or the third timer doesn't expire), and in case of a beam failure instance indication related to the second procedure is indicated or received. For example, from the lower layers of the terminal device. In some embodiments, the beam failure instance indication may be based on the second set of RSs. In some embodiments, the terminal device 120 may increase the third counter by 1, within a duration before the third timer expires (or the third timer doesn't expire), and in case of the second counter is increased by 1. In some embodiments, the third timer may be set to 0, in case of the third timer expires.

In some embodiments, the terminal device 120 may start or restart the third timer, in case of a beam failure instance indication related to the second procedure is indicated or received. For example from the lower layers of the terminal device. In some embodiments, the beam failure instance indication may be based on the second set of RSs. In some embodiments, the terminal device 120 may start or restart the third timer, in case of the second counter is increased by 1. In some embodiments, the terminal device 120 may increase the third counter by 1, within a duration before the third timer expires (or the third timer doesn't expire), and in case of a beam failure instance indication related to the first procedure is indicated or received. For example, from the lower layers of the terminal device. In some embodiments, the beam failure instance indication may be based on the first set of RSs. In some embodiments, the terminal device 120 may increase the third counter by 1, within a duration before the third timer expires (or the third timer doesn't expire), and in case of the first counter is increased by 1. In some embodiments, the third timer may be set to 0, in case of the third timer expires.

In some embodiments, the third timer may be started or restarted based on at least one of: a beam failure instance indication is indicated or received related to either the first procedure or the second procedure, in case of the value of the first counter is 0, in case of the value of the second counter is 0, and a beam failure instance indication is indicated or received related to one of the first procedure or the second procedure, wherein the first procedure or the second procedure is configured with a smaller value between the first timer and the second timer or configured with a higher priority.

In some embodiments, the terminal device 120 may cancel all triggered BFRs related to any one of the first procedure and the second procedure, in case of a BFR or a random access procedure related to the third procedure is triggered or initiated.

In some embodiments, the terminal device 120 may stop the first procedure and the second procedure, in case of a BFR or a random access procedure related to the third procedure is triggered or initiated.

In some embodiments, a BFR or a random access procedure related to the third procedure is triggered or initiated before a timing, wherein the timing comprises at least one of: a beam failure recovery related to the first procedure is successfully completed; and a beam failure recovery related to the second procedure is successfully completed.

In some embodiments, a BFR related to the third procedure is triggered is same with a random access procedure is initiated.

In some embodiments, the terminal device 120 may transmit a random access preamble to the network device, in case of a random access procedure related to the third procedure is initiated or in case of a beam failure recovery related to the third procedure is triggered.

In some embodiments, the terminal device 120 may determine a power for the random access preamble transmission related to the third procedure, based on at least one of a power parameter and number of beam failure recovery request transmissions related to at least one of the first procedure and the second procedure.

In some embodiments, the terminal device 120 may communicate with the network device 110 based on the first TRP and the second TRP of the cell. In some embodiments, the terminal device 120 may communicate with the network device 110 based on a single TRP of the cell after a timing, wherein the timing may be at least one of: a BFR related to the third procedure is triggered; a random access procedure related to the third procedure is initiated; and a beam failure recovery related to the third procedure is successfully completed.

In some embodiments, there may be a third set of RSs (for example, NBI_set_0) for new/candidate beam identification related to the third procedure. In some embodiments, the terminal device 120 may receive one or more configurations of the third set of RSs for new/candidate beam identification from the network device 110. In some embodiments, the terminal device 120 may determine the third set of RSs for new/candidate beam identification based on the first set of RSs for new/candidate beam identification and the second set of RSs for new/candidate beam identification. In some embodiments, the third set of RSs for new/candidate beam identification may be a union set of the first set of RSs for new/candidate beam identification and the second set of RSs for new/candidate beam identification. For example, NBI_set_0=candidateBeamRSList_1∪candidateBeamRSList_2. In some embodiments, at least one RS in the third set of RSs for new/candidate beam identification is different from any one of RS in the first set of RSs for new/candidate beam identification and the second set of RSs for new/candidate beam identification.

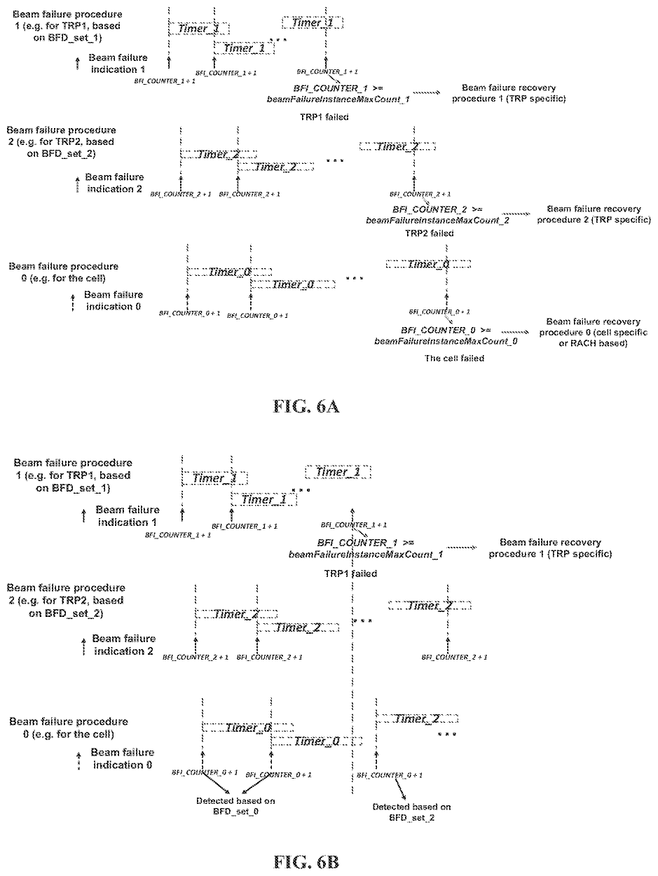

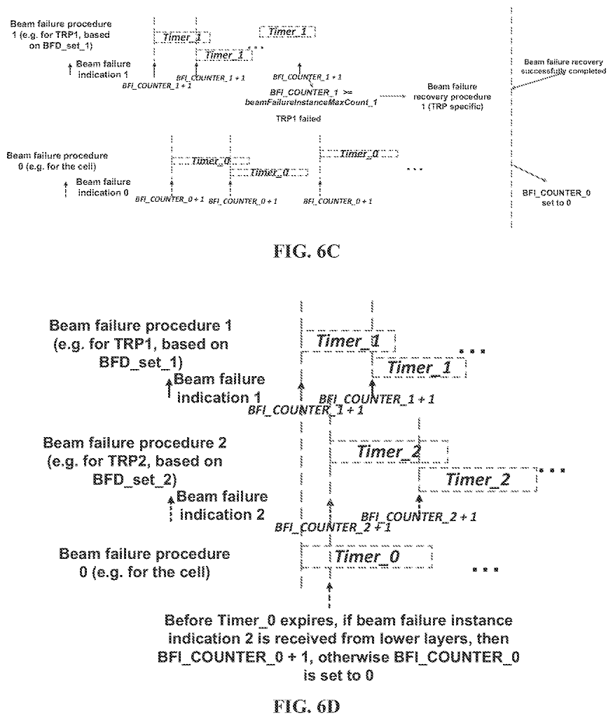

FIGS. 6A-6D illustrate examples in accordance with some embodiments of the present disclosure.

As shown in FIG. 6A, the terminal device 120 may be configured with a first timer (Time_1) in a first procedure (beam failure procedure 1). For example, the first procedure is for the first TRP (TRP1). And the beam failure detection is based on the first set of RSs for beam failure detection (BFD_set_1). For example, if a beam failure indication 1 is received from lower layers of the terminal device, the value of a first counter (BFI_COUNTER_1) is increased by 1. For example, if BFI_COUNTER_1 is larger than or equal to the first maximum value (beamFailureInstanceMaxCount_1), a BFR is triggered for the first procedure. For example, the first TRP (TRP1) is failed. And the terminal device 120 may be configured with a second timer (Time_2) in a second procedure (beam failure procedure 2). For example, the second procedure is for the second TRP (TRP2). And the beam failure detection is based on the second set of RSs for beam failure detection (BFD_set_2). For example, if a beam failure indication 2 is received from lower layers of the terminal device, the value of a second counter (BFI_COUNTER_2) is increased by 1. For example, if BFI_COUNTER_2 is larger than or equal to the second maximum value (beamFailureInstanceMaxCount_2), a BFR is triggered for the second procedure. For example, the second TRP (TRP2) is failed. For example, the terminal device 120 may be configured with a third timer (Time_0) in a third procedure (beam failure procedure 0). For example, the third procedure is for the cell, and the first TRP and the second TRP are configured in the cell. For example, if a beam failure indication 0 is received from lower layers of the terminal device, the value of a third counter (BFI_COUNTER_0) is increased by 1. For example, if BFI_COUNTER_0 is larger than or equal to the third maximum value (beamFailureInstanceMaxCount_0), a BFR is triggered for the third procedure. For example, the cell is failed.

In some embodiments, the set of RSs for beam failure detection and/or the timer for beam failure detection related to the third procedure may depend on a first condition in the first procedure and/or in the second procedure. In some embodiments, the first condition may be at least one of: a BFR is triggered in the first procedure, a BFR is triggered in the second procedure, before beam failure recovery is successfully completed in the first procedure, and before beam failure recovery is successfully completed in the second procedure.

In some embodiments, if the first condition is satisfied (for example, a BFR is triggered in the first procedure and/or before beam failure recovery is successfully completed in the first procedure), beam failure detection related to the third procedure may be based on the second set of RSs for beam failure detection and/or the second timer. For example, if the first condition is satisfied, and if a beam failure instance indication is indicated or received from the lower layers of the terminal device, the terminal device may start or restart the second timer.

In some embodiments, if the first condition is not satisfied (For example, a BFR is not triggered in the first procedure and/or the second procedure and/or beam failure recovery is successfully completed in the first procedure and/or the second procedure), beam failure detection related to the third procedure may be based on the third set of RSs for beam failure detection and/or the third timer. For example, if the first condition is not satisfied, and if a beam failure instance indication is indicated or received from the lower layers of the terminal device, the terminal device may start or restart the third timer.

As shown in FIG. 6B, the terminal device 120 may be configured with a first timer (Time_1) in a first procedure (beam failure procedure 1). For example, the first procedure is for the first TRP (TRP1). And the beam failure detection is based on the first set of RSs for beam failure detection (BFD_set_1). For example, if a beam failure indication 1 is received from lower layers of the terminal device, the value of a first counter (BFI_COUNTER 1) is increased by 1. For example, if BFI_COUNTER_1 is larger than or equal to the first maximum value (beamFailureInstanceMaxCount_1), a BFR is triggered for the first procedure. For example, the first TRP (TRP1) is failed. For example, the terminal device 120 may be configured with a second timer (Time_2) in a second procedure (beam failure procedure 2). For example, the second procedure is for the second TRP (TRP2). And the beam failure detection is based on the second set of RSs for beam failure detection (BFD_set_2). For example, if a beam failure indication 2 is received from lower layers of the terminal device, the value of a second counter (BFI_COUNTER_2) is increased by 1. For example, if BFI_COUNTER_2 is larger than or equal to the second maximum value (beamFailureInstanceMaxCount_2), a BFR is triggered for the second procedure. For example, the second TRP (TRP2) is failed. For example, the terminal device 120 may be configured with a third timer (Time_0) in a third procedure (beam failure procedure 0). For example, the third procedure is for the cell, and the first TRP and the second TRP are configured in the cell. For example, if BFI_COUNTER_1 is larger than or equal to beamFailureInstanceMaxCount_1, or if the first TRP is failed, beam failure detection in the third procedure may be based on the second set of RSs for beam failure detection (BFD_set_2). For another example, if BFI_COUNTER_1 is less than beamFailureInstanceMaxCount_1, or if the first TRP is not failed, beam failure detection in the third procedure may be based on the third set of RSs for beam failure detection (BFD_set_0). For another example, a beam failure indication 0 is received from lower layers of the terminal device, the value of a third counter (BFI_COUNTER_0) is increased by 1. For another example, if BFI_COUNTER_1 is larger than or equal to beamFailureInstanceMaxCount_1, or if the first TRP is failed, and if a beam failure indication 0 is received from lower layers of the terminal device, the terminal device may start or restart the second timer (Timer 2). For another example, if BFI_COUNTER_1 is less than beamFailureInstanceMaxCount_1, or if the first TRP is not failed, and if a beam failure indication 0 is received from lower layers of the terminal device, the terminal device may start or restart the third timer (Timer_0).

In some embodiments, at least one of the following terminal device variables may be used for the beam failure detection procedures:
BFI_COUNTER_0 (per Serving Cell): counter for beam failure instance indication which is initially set to 0;
BFI_COUNTER_1 (if TRP-specific BFR is configured, and for TRP1 of the Serving Cell): counter for beam failure instance indication which is initially set to 0;
BFI_COUNTER_2 (if TRP-specific BFR is configured, and for TRP2 of the Serving Cell): counter for beam failure instance indication which is initially set to 0.

In some embodiments, the MAC entity of the terminal device shall for each for each Serving Cell configured for beam failure detection and configured with TRP-specific BFR and cell-specific BFR:

(For example, the first procedure related)
1> if beam failure instance indication detected based on the first set of RSs for beam failure detection has been received from lower layers:
   2> start or restart the beamFailureDetectionTimer_1;
   2>increment BFI_COUNTER_1 by 1;
   2> if BFI_COUNTER_1>=beamFailureInstanceMaxCount_1:
      3>trigger a BFR for the first TRP of this Serving Cell;
1> if the beamFailureDetectionTimer_1 expires; or
1> if beam FailureDetectionTimer_1, beamFailureInstanceMaxCount_1, or any of the reference signals used for beam failure detection is reconfigured (For example, by upper layers or by lower layers or by physical layer) associated with for the first TRP of this Serving Cell:
   2> set BFI_COUNTER_1 to 0;
   2> set BFI_COUNTER_0 to 0.
1> if a PDCCH addressed to C-RNTI indicating uplink grant for a new transmission is received for the HARQ process used for the transmission of the BFR MAC CE or Truncated BFR MAC CE which contains beam failure recovery information of the first TRP of this Serving Cell:
   2> set BFI_COUNTER_1 to 0;
   2> set BFI_COUNTER_0 to 0.
   2>consider the Beam Failure Recovery procedure for the first TRP successfully completed and cancel all the triggered BFRs related to the first TRP for this Serving Cell.

(For example, the second procedure related)
1> if beam failure instance indication detected based on the second set of RSs for beam failure detection has been received from lower layers:
   2> start or restart the beamFailureDetectionTimer_2;
   2>increment BFI_COUNTER_2 by 1;
   2> if BFI_COUNTER_2>=beamFailureInstanceMaxCount_2:
      3>trigger a BFR for the second TRP of this Serving Cell;
1> if the beamFailureDetectionTimer_2 expires; or
1> if beamFailureDetectionTimer_2, beamFailureInstanceMaxCount_2, or any of the reference signals used for beam failure detection is reconfigured (For example, by upper layers or by lower layers or by physical layer) for the second TRP of this Serving Cell:
   2> set BFI_COUNTER_2 to 0;
   2> set BFI_COUNTER_0 to 0.
1> if a PDCCH addressed to C-RNTI indicating uplink grant for a new transmission is received for the HARQ process used for the transmission of the BFR MAC CE or Truncated BFR MAC CE which contains beam failure recovery information of the second TRP of this Serving Cell:
   2> set BFI_COUNTER_2 to 0;
   2> set BFI_COUNTER_0 to 0.
   2>consider the Beam Failure Recovery procedure for the second TRP successfully completed and cancel all the triggered BFRs related to the second TRP for this Serving Cell.

(For example, the third procedure related)
1> if beam failure instance indication detected for the cell has been received from lower layers:
   2> start or restart the beamFailureDetectionTimer_0;
   2>increment BFI_COUNTER_0 by 1;
   2> if BFI_COUNTER_0>=beamFailureInstanceMaxCount_0:
      3> if the Serving Cell is SCell:
         4>trigger a BFR for this Serving Cell;
         4>stop the procedure of P1 and P2, if configured;
      3> else:
         4> initiate a Random Access procedure on the SpCell.
         4>stop the procedure of P1 and P2, if configured;
1> if the beamFailureDetectionTimer_0 expires; or
1> if beamFailureDetectionTimer_0, beamFailureInstanceMaxCount_0, or any of the reference signals used for beam failure detection is reconfigured (For example, by upper layers or by lower layers or by physical layer) for this Serving Cell:
   2> set BFI_COUNTER_0 to 0.
1> if the Serving Cell is SpCell and the Random Access procedure initiated for SpCell beam failure recovery is successfully completed:
   2> set BFI_COUNTER_0 to 0;
   2>stop the beamFailureRecoveryTimer_0, if configured;
   2>consider the Beam Failure Recovery procedure successfully completed.
1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated as specified in clause 5.9:
   2> set BFI_COUNTER_0 to 0;
   2>consider the Beam Failure Recovery procedure successfully completed and cancel all the triggered BFRs (including P1 and P2) for this Serving Cell.

In some embodiments, there may be all or a subset of steps as disclosed in embodiment applied for at least one of the first procedure, the second procedure and the third procedure.

As shown in FIG. 6C, the terminal device 120 may be configured with a first timer (Time_1) in a first procedure (beam failure procedure 1). For example, the first procedure is for the first TRP (TRP1). And the beam failure detection is based on the first set of RSs for beam failure detection (BFD_set_1). For example, if a beam failure indication 1 is received from lower layers of the terminal device, the value of a first counter (BFI_COUNTER_1) is increased by 1. For example, if BFI_COUNTER_1 is larger than or equal to the first maximum value (beamFailureInstanceMaxCount_1), a BFR is triggered for the first procedure. For example, the first TRP (TRP1) is failed. For example, the terminal device 120 may be configured with a third timer (Time_0) in a third procedure (beam failure procedure 0). For example, the third procedure is for the cell, and the first TRP and the second TRP are configured in the cell. For example, if BFI_COUNTER_1 is larger than or equal to beamFailureInstanceMaxCount_1, or if the first TRP is failed, beam failure recovery procedure 1 is performed. For another example, if beam failure recovery is successfully completed related to the first procedure, the value of BFI_COUNTER_0 is set to 0 related to the third procedure.

In some embodiments, in case of a BFR is triggered related to either one of the first procedure or the second procedure, and within the first duration, if a BFR or a random access procedure is triggered related to the third procedure, the first procedure or the second procedure is cancelled or the value of BFI_COUNTER_0 is set to 0 or the value of the BFI_COUNTER_1 is set to 0. For example, the terminal device may perform beam failure recovery related to the third procedure. For example, the terminal device may select a new candidate RS from the third set of RS for new/candidate beam identification.

In some embodiments, in case of a BFR is triggered related to either one of the first procedure or the second procedure, and within the first duration, if the value of BFI_COUNTER_0 is larger than or equal to the third maximum value, a BFR or a random access procedure may be triggered related to the third procedure. In some embodiments, the first procedure or the second procedure is cancelled or the value of BFI_COUNTER_1 is set to 0 or the value of the BFI_COUNTER_2 is set to 0. For example, the terminal device may perform beam failure recovery related to the third procedure. For example, the terminal device may select a new candidate RS from the third set of RS for new/candidate beam identification. In some embodiments, within the first duration, and if a BFR or a random access procedure is not triggered related to the third procedure or if the value of BFI_COUNTER_0 is less than the third maximum value, the value of BFI_COUNTER_0 is set to 0.

In some embodiments, in case of a BFR is triggered related to either one of the first procedure or the second procedure, the terminal device may start or restart the third timer, and before the third timer expires, if a BFR or a random access procedure is triggered related to the third procedure, the first procedure or the second procedure is cancelled or the value of BFI_COUNTER_1 is set to 0 or the value of the BFI_COUNTER_2 is set to 0. For example, the terminal device may perform beam failure recovery related to the third procedure. For example, the terminal device may select a new candidate RS from the third set of RS for new/candidate beam identification.

In some embodiments, the terminal device 120 may receive a configuration of the first duration from the network device 110. In some embodiments, the first duration may be between a timing when a BFR is triggered related to either the first procedure or the second procedure and a timing when the beam failure recovery procedure is successfully completed related to either the first procedure or the second procedure. In some embodiments, the first duration may be from a timing when a BFR is triggered related to either the first procedure or the second procedure to a timing when the beam failure recovery procedure is successfully completed related to either the first procedure or the second procedure.

In some embodiments, in case of a BFR is triggered related to either one of the first procedure or the second procedure, the terminal device may start or restart the third timer, and before the third timer expires, if the value of BFI_COUNTER_0 is larger than or equal to the third maximum value, a BFR or a random access procedure may be triggered related to the third procedure. In some embodiments, the first procedure or the second procedure is cancelled or the value of BFI_COUNTER_0 is set to 0 or the value of the BFI_COUNTER_1 is set to 0. For example, the terminal device may perform beam failure recovery related to the third procedure. For example, the terminal device may select a new candidate RS from the third set of RS for new/candidate beam identification. In some embodiments, if the third timer expires, and if a BFR or a random access procedure is not triggered related to the third procedure or if the value of BFI_COUNTER_0 is less than the third maximum value, the value of BFI_COUNTER_0 is set to 0. In some embodiments, before the third timer expires, and if a BFR or a random access procedure is not triggered related to the third procedure or if the value of BFI_COUNTER_0 is less than the third maximum value, the value of BFI_COUNTER_0 is set to 0.

As shown in FIG. 6D, the terminal device 120 may be configured with a first timer (Time_1) in a first procedure (beam failure procedure 1). For example, the first procedure is for the first TRP (TRP1). And the beam failure detection is based on the first set of RSs for beam failure detection (BFD_set_1). For example, if a beam failure indication 1 is received from lower layers of the terminal device, the value of a first counter (BFI_COUNTER_1) is increased by 1. For example, if BFI_COUNTER_1 is larger than or equal to the first maximum value (beamFailureInstanceMaxCount_1), a BFR is triggered for the first procedure. For example, the first TRP (TRP1) is failed. For example, the terminal device 120 may be configured with a second timer (Time_2) in a second procedure (beam failure procedure 2). For example, the second procedure is for the second TRP (TRP2). And the beam failure detection is based on the second set of RSs for beam failure detection (BFD_set_2). For example, if a beam failure indication 2 is received from lower layers of the terminal device, the value of a second counter (BFI_COUNTER_2) is increased by 1. For example, if BFI_COUNTER_2 is larger than or equal to the second maximum value (beamFailureInstanceMaxCount_2), a BFR is triggered for the second procedure. For example, the second TRP (TRP2) is failed. For example, the terminal device 120 may be configured with a third timer (Time_0) in a third procedure (beam failure procedure 0). For example, the third procedure is for the cell, and the first TRP and the second TRP are configured in the cell. For example, if a beam failure indication 1 related to the first procedure is received from lower layers of the terminal device, the value of a first counter (BFI_COUNTER_1) is increased by 1, and the terminal device 120 may start or restart the third timer (Timer_0). For example, within the duration before the third timer (Timer_0) expires, if beam failure instance indication 2 is indicated or received related to the second procedure, then the value of BFI_COUNTER_0 is increased by 1. For another example, if the third timer (Timer_0) expires, the value of BFI_COUNTER_0 is set to 0.

In some embodiments, the first timer related to the first procedure may be smaller than or no larger than the second timer related to the second procedure. In some embodiments, the terminal device may receive one or more configurations of priority for at least one of the first procedure and the second procedure. In some embodiments, the first procedure may be configured with a priority higher than the second procedure. In some embodiments, the first procedure may be configured with a priority lower than the second procedure.

In some embodiments, if a BFR is triggered related to the second procedure or if the value of the second counter is larger than or equal to the second maximum value related to the second procedure, the terminal device may perform a TRP specific BFR procedure. For example, no BFR is triggered related to the first procedure. In some embodiments, if a BFR is triggered related to the first procedure or if the value of the first counter is larger than or equal to the first maximum value related to the first procedure, the terminal device may perform a random access procedure or a cell specific BFR procedure. In some embodiments, the terminal device may be configured with the first procedure and the second procedure on a BWP of the cell. For example, the first procedure may be a cell specific BFR procedure or a random access based procedure. For example, the second procedure may be a TRP specific BFR procedure. In some embodiments, the first procedure may be configured with a higher priority than the second procedure.

In some embodiments, if the value of the first counter is larger than or equal to the first maximum value related to the first procedure, the terminal device may start to perform the second procedure. For example, if within a duration, the value of the second counter is larger than or equal to the second maximum value related to the second procedure, then a random access procedure may be initiated or a cell specific BFR related to the third procedure may be triggered, otherwise, a BFR related to the first procedure may be triggered.

In some embodiments, if the value of the first counter is larger than or equal to the first maximum value related to the first procedure, the terminal device may start or restart the third timer, and the value of the second counter may be set to 0, and beam failure detection may be based on the second set of RSs for beam failure detection related to the second procedure. In some embodiments, before the third timer expires or within a duration before the third timer expires, and if the value of the second counter is larger than or equal to the second maximum value, the terminal device may initiate a random access procedure or a cell specific BFR procedure, otherwise, the terminal device may trigger a BFR related to the first procedure.

In some embodiments, the new candidate beam/RS for the random access procedure or the cell specific BFR procedure is same with the new candidate beam/RS related to the first procedure. In some embodiments, the new candidate beam/RS for the random access procedure or the cell specific BFR procedure is selected based on the first set of RSs for new/candidate beam identification.

In some embodiments, if a BFR is triggered or a random access procedure is triggered related to the third procedure, then multi-TRP transmission (based on the first TRP and the second TRP) falls back to single-TRP transmission between the network device and the terminal device. In some embodiments, if a BFR is triggered or a random access procedure is triggered related to the third procedure, then communication between the network device and the terminal device changes from based on the first TRP and the second TRP to based on a single TRP.

In some embodiments, the power for a random access preamble transmission related to the third procedure may be determined based on one or more power parameters and/or a number of beam failure recovery request (BFRQ) transmissions related to at least one of the first procedure and the second procedure.

In some embodiments, the initial power for the random access preamble transmission related to the third procedure may be determined based on the maximum one of a reference power for scheduling request (SR) or beam failure request (BFR) or BFRQ transmission between the first procedure and the second procedure.

In some embodiments, there may be a parameter (For example, BfrqTrans_COUNTER_1) for counting a number of BFRQ transmissions within a duration related to the first procedure. In some embodiments, BfrqTrans_COUNTER_1 may be a non-negative integer. For example, 0<=BfrqTrans_COUNTER_1<=BfrqTrans_MaxCount_1. For example, BfrqTrans_MaxCount_1 is a positive integer. For another example, 1<=BfrqTrans_MaxCount_1<=100. For another example, BfrqTrans_MaxCount_1 may be configured by the network device.

In some embodiments, there may be a parameter (For example, BfrqTrans_COUNTER_2) for counting a number of BFRQ transmissions within a duration related to the second procedure. In some embodiments, BfrqTrans_COUNTER_2 may be a non-negative integer. For example, 0<=BfrqTrans_COUNTER_2 BfrqTrans_MaxCount_2. For example, BfrqTrans_MaxCount_2 is a positive integer. For another example, 1<=BfrqTrans_MaxCount_2<=100. For another example, BfrqTrans_MaxCount_2 may be configured by the network device.

In some embodiments, the duration may be between a timing when a BFR is triggered in the first procedure or the second procedure, and a timing when beam failure recovery is successfully completed in the first procedure or the second procedure. In some embodiments, the duration may be between a timing when a BFR is triggered in the first procedure or the second procedure, and a timing when a BFR is triggered or a random access procedure is initiated related to the third procedure. For example, the timing when a BFR is triggered or a random access procedure is initiated related to the third procedure is earlier than or no later than the timing when beam failure recovery is successfully completed in the first procedure or the second procedure. In some embodiments, the duration may be between the first BFRQ transmission and the BFRQ transmission with an index of BfrqTrans_COUNTER_1 or BfrqTrans_COUNTER_2 related to the first procedure or the second procedure.

In some embodiments, the power for the random access preamble transmission related to the third procedure may be determined based on BfrqTrans_COUNTER_1 and/or BfrqTrans_COUNTER_2.

In some embodiments, if a random access procedure related to the third procedure is triggered or initiated, the value of PREAMBLE_POWER_RAMPING_COUNTER may value between BfrqTrans_COUNTER_1 and be set to the maximum BfrqTrans_COUNTER_2. For example, PREAMBLE_POWER_RAMPING_COUNTER=max(BfrqTrans_COUNTER_1, BfrqTrans_COUNTER_2) or max(BfrqTrans_MaxCount_1. BfrqTrans_MaxCount_2). For example, for the first random access preamble transmission.

In some embodiments, if a random access procedure related to the third procedure is triggered or initiated, PREAMBLE_RECEIVED_TARGET_POWER may be determined based on (PREAMBLE_POWER_RAMPING_COUNTER+max(BfrqTrans_COUNTER_1, BfrqTrans_COUNTER_2)−1)×PREAMBLE_POWER_RAMPING_STEP or (PREAMBLE_POWER_RAMPING_COUNTER max(BfrqTrans_MaxCount_1. BfrqTrans_MaxCount_2)−1)×PREAMBLE_POWER_RAMPING_STEP. For example, for the first random access preamble transmission.

In some embodiments, the power for the random access preamble transmission related to the third procedure may be determined based on a power offset (For example, POWER_OFFSET_BFRQ), wherein the power offset may be determined based on the BFRQ transmission(s) in the first procedure and/or the second procedure.

In some embodiments, if a random access procedure related to the third procedure is triggered or initiated, PREAMBLE_RECEIVED_TARGET_POWER may be determined based on preambleReceivedTargetPower+POWER_OFFSET_BFRQ. For example, for the first random access preamble transmission.

In some embodiments, the power offset may be determined based on the offset between the power for a first BFRQ transmission and a maximum value of power for BFRQ transmission within the duration related to the first procedure and/or the second procedure.

In some embodiments, the power offset may be determined based on an offset between the power caused by transmission power control (TPC) for the first BFRQ transmission and the maximum/peak value of (accumulated) TPC within the duration related to the first procedure and/or the second procedure. For example, the power offset may be max(TPC_1, TPC_2) or max(max(TPC_1, TPC_2), 0). For example, TPC_1 may be related to the first procedure. For another example, TPC_2 may be related to the second procedure.

In some embodiments, the first procedure, the second procedure and the third procedure may be configured simultaneously for the cell. In some embodiments, the first procedure and the second procedure may be configured simultaneously for a BWP for the cell. In some embodiments, the first procedure/the second procedure and the third procedure may not be configured simultaneously for a same BWP for the cell. For example, the first procedure and the second procedure may be configured for a first BWP. For example, the first BWP is configured with the first TRP and the second TRP. For another example, the third procedure may not be configured for the first BWP. For another example, the third procedure may be configured for a second BWP. For example, the second BWP may be configured with a single TRP.

In some embodiments, if the active BWP is changed or switched from the first BWP to the second BWP, the first procedure and the second procedure may be stopped or cancelled, and the third procedure may be performed. In some embodiments, beam failure detection related to the third procedure may be based on the first set of RSs and/or the first timer for beam failure detection. In some embodiments, if the active BWP is changed or switched from the first BWP to the second BWP, the first procedure may be stopped or cancelled, and the third procedure and the second procedure may be performed. And if a BFR is triggered related to the second procedure, a BFRQ is transmitted and no PDCCH monitoring based on the beam/RS related to the second procedure.

In some embodiments, if the active BWP is changed or switched from the second BWP to the first BWP, the third procedure may be stopped or cancelled, and the first procedure and the second procedure may be performed. In some embodiments, if the active BWP is changed or switched from the second BWP to the first BWP, the first procedure and the second procedure may be started to be performed.

In some embodiments, the terminal device 120 may receive a detected downlink control information (DCI), and the detected DCI may indicate a BWP switching and a TCI state. And the detected DCI may schedule a PDSCH transmission. The terminal device may applied the indicated TCI state to the scheduled PDSCH after BWP switching.

In some embodiments, the terminal device may receive a first detected DCI on a first BWP, wherein the first detected DCI may indicate a second BWP. In some embodiments, the terminal device may receive an indication of a combination of a first TCI state and a second TCI state. In some embodiments, the terminal device may discard the second TCI state for a communication between the terminal device and the network device based on a configuration of the second BWP. For example, the communication may be receiving a set of CORESETs, PDSCH and RS from the network device. For another example, the communication may be transmitting a set of PUCCHs, PUSCH and RS to the network device. In some embodiments, the indication of the combination may be received in the first detected DCI or in a second detected DCI. For example, the second detected DCI may be received later than or no earlier than the first detected DCI.

In some embodiments, the terminal device may receive a first set of CORESETS with the first TCI state after a timing on the second BWP, and the terminal device may transmit a first set of PUCCHs with the first TCI state after the timing on a first uplink BWP, and the terminal device may transmit a second set of PUCCHs with the second TCI state after the timing on the first uplink BWP. For example, the second TCI state may not be applied for a downlink reception on the second BWP. For example, the second BWP is a downlink BWP.

In some embodiments, the terminal device may receive a configuration of the first set of CORESETs for the second BWP, wherein the second BWP is a downlink BWP. In some embodiments, the terminal device may receive one or more configurations of the first set of PUCCHs and the second set of PUCCHs for the first uplink BWP.

In some embodiments, the terminal device may receive the second set of CORESETs with the first TCI state after the timing on the first BWP, and the terminal device may receive the third set of CORESETs with the second TCI state after the timing, and the terminal device may transmit a third set of PUCCHs with the first TCI state after the timing on the second BWP. For example, the second TCI state may not be applied for an uplink transmission on the second BWP, wherein the second BWP may be an uplink BWP.

In some embodiments, the terminal device may receive a configuration of the third set of PUCCHs for the second BWP, wherein the second BWP is an uplink BWP.

In some embodiments, the terminal device may receive one or more configurations of the first BWP and the second BWP for the cell. In some embodiments, the terminal device may receive a configuration of the first uplink BWP for the cell.

In some embodiments, the terminal device may receive an activation command, wherein the activation command is used to map a set of combinations of one or two TCI states to a set of codepoints, wherein the set comprises the combination of the first TCI state and the second TCI state.

In some embodiments, the terminal device may be configured with a first downlink BWP, and the first downlink BWP may be configured with two TRPs. For example, the first TRP and the second TRP. In some embodiments, the terminal device may be configured with a first uplink BWP, wherein the first uplink BWP may be configured with two TRPs. For example, the first TRP and the second TRP. In some embodiments, the terminal device may be configured with a first subset of CORESETs and a second subset of CORESETs on the first downlink BWP. For example, a first TCI state (for example, a first joint TCI) may be applied for the first subset of CORESETs. For another example, a second TCI state (for example, a second joint TCI) may be applied for the second subset of CORESETs. In some embodiments, the terminal device may be configured with a third subset of CORESETs on a second downlink BWP. For example, the second downlink BWP may be configured with a single TRP. For example, the first TRP. For another example, a third TCI state (for example, a third joint TCI) may be indicated or applied for the third subset of CORESETs. For example, the third subset of CORESETs may be same with either one of the first subset of CORESETs or the second subset of CORESETs.

In some embodiments, the terminal device may receive a first detected DCI, wherein the first detected DCI may indicate a downlink BWP switching. For example, from the first downlink BWP to the second downlink BWP. In some embodiments, the terminal device may receive an indication of a combination of a third TCI state and a fourth TCI state. In some embodiments, only one of the third TCI state and the fourth TCI state which is associated with the third subset of CORESETs is applied for downlink reception and/or uplink transmission. For example, applied for the third subset of CORESETS.

In some embodiments, the third TCI state is applied for downlink reception (for example, applied for the third subset of CORESETs) on the second downlink BWP, and the fourth TCI state is not applied for downlink reception (for example, not applied to any one of CORESET or PDSCH) on the second downlink BWP. In some embodiments, both the third TCI state and the fourth TCI state may be applied for uplink transmission on the first uplink BWP.

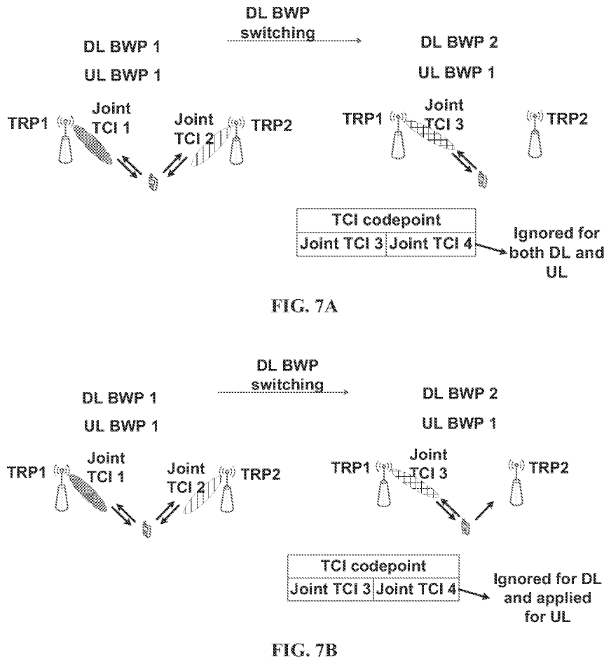

FIGS. 7A-7B illustrate examples in accordance with some embodiments of the present disclosure.

As shown in FIG. 7A, the terminal device 120 may be configured with a first downlink BWP (DL BWP 1) and an uplink BWP (UL BWP 1). For example, the terminal device 120 may be configured with a second downlink BWP (DL BWP 2). For example, the DL BWP 1 and the UL BWP 1 may be configured with two TRPs (TRP1 and TRP2). For example, the second downlink BWP may be configured with one TRP (TRP1). For example, joint TCI 1 may be applied for uplink and downlink communication between the terminal device and the network device with TRP1. For another example, joint TCI 2 may be applied for uplink and downlink communication between the terminal device and the network device with TRP2. For example, the terminal device may receive a downlink BWP switching (from DL BWP 1 to DL BWP 2). For example, the terminal device may receive a TCI codepoint corresponding to joint TCI 3 and joint TCI 4. For example, after BWP switching, the joint TCI 4 may be ignored or discarded for uplink and downlink communication between the terminal device and the network device. For example, based on TRP2.

As shown in FIG. 7B, the terminal device 120 may be configured with a first downlink BWP (DL BWP 1) and an uplink BWP (UL BWP 1). For example, the terminal device 120 may be configured with a second downlink BWP (DL BWP 2). For example, the DL BWP 1 and the UL BWP 1 may be configured with two TRPs (TRP1 and TRP2). For example, the second downlink BWP may be configured with one TRP (TRP1). For example, joint TCI 1 may be applied for uplink and downlink communication between the terminal device and the network device with TRP1. For another example, joint TCI 2 may be applied for uplink and downlink communication between the terminal device and the network device with TRP2. For example, the terminal device may receive a downlink BWP switching (from DL BWP 1 to DL BWP 2). For example, the terminal device may receive a TCI codepoint corresponding to joint TCI 3 and joint TCI 4. For example, after BWP switching, the joint TCI 4 may be ignored or discarded for downlink communication between the terminal device and the network device. For example, based on TRP2. For another example, after BWP switching, the joint TCI 4 may be applied for uplink communication between the terminal device and the network device. For example, based on TRP2.

In some embodiments, the timing may be a beam application timing. For example, the timing may be the first slot or first subslot that is at least X ms or Y symbols after the last symbol of the acknowledge of the first detected DCI or the second detected DCI.

In some embodiments, the network device 110 may transmit to the terminal device 120, a first DCI on a first BWP, wherein the first DCI indicates a second BWP, and transmit an indication of a combination of a first TCI state and a second TCI state, and the network device 110 may discard the second TCI state for a communication between the network device 110 and the terminal device 120 based on a configuration of the second BWP.

In some embodiments, the network device 110 may transmit the indication of the combination in the first DCI or in a second DCI. For example, the second DCI is transmitted later than or no earlier than the first DCI.

In some embodiments, the network device 110 may transmit a first set of control resource sets (CORESETs) with the first TCI state after a timing on the second BWP; and receive a first set of physical uplink control channels (PUCCHs) with the first TCI state after the timing on a first uplink BWP; and receive a second set of PUCCHs with the second TCI state after the timing on the first uplink BWP; and the second TCI state is not applied for a downlink transmission on the second BWP, wherein the second BWP is a downlink BWP.

In some embodiments, the network device 110 may transmit a configuration of the first set of CORESETs for the second BWP, wherein the second BWP is a downlink BWP; and transmit one or more configurations of the first set of PUCCHs and the second set of PUCCHs for the first uplink BWP.

In some embodiments, the network device 110 may transmit one or more configurations of a second set of CORESETs and a third set of CORESETs for the first BWP, wherein the first BWP is a downlink BWP.

In some embodiments, the network device 110 may transmit the second set of CORESETs with the first TCI state after the timing on the first BWP; and transmit the third set of CORESETs with the second TCI state after the timing on the first BWP; and receive a third set of physical uplink control channels (PUCCHs) with the first TCI state after the timing on the second BWP; and the second TCI state is not applied for an uplink reception on the second BWP, wherein the second BWP is an uplink BWP.

In some embodiments, the network device 110 may transmit a configuration of the third set of PUCCHs for the second BWP, wherein the second BWP is an uplink BWP.

In some embodiments, the network device 110 may transmit one or more configurations of the first BWP and the second BWP for a cell.

In some embodiments, the network device 110 may transmit a configuration of the first uplink BWP for the cell.

In some embodiments, the network device 110 may transmit an activation command to map a set of combinations of one or two TCI states to a set of codepoints, wherein the set comprises the combination of the first TCI state and the second TCI state.

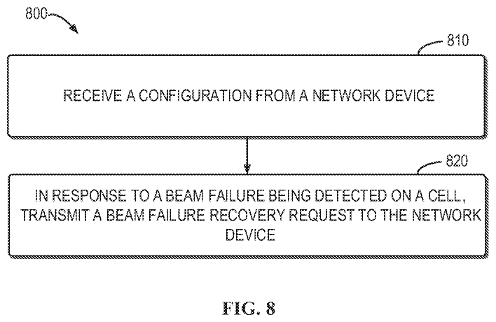

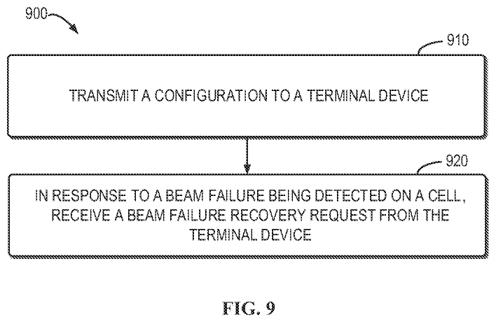

FIG. 8 illustrates a flowchart of an example method 800 in accordance with some embodiments of the present disclosure. For example, the method 800 can be implemented at the terminal device 120 as shown in FIG. 1.

At block 810, the terminal device 120 receives a configuration from a network device (for example, the network device 110 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device.

At block 820, in response to a beam failure being detected on a cell in the group of cells, the terminal device 120 transmits a beam failure recovery request to the network device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new/candidate beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a first set of RSs for new/candidate beam identification, and the second subset of cells may be configured with a second set of RSs for beam failure detection and a second set of RSs for new/candidate beam identification.

In some embodiments, in response to a beam failure being detected based on the first set of RSs, the terminal device 120 may transmit a first beam failure recovery request to the network device, where the first beam failure recovery request at least comprises an indication of the first TRP or the first subset of cells. In response to a beam failure being detected based on the second set of RSs for beam failure detection, the terminal device 120 may transmit a second beam failure recovery request to the network device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

FIG. 9 illustrates a flowchart of an example method 900 in accordance with some embodiments of the present disclosure. For example, the method 900 can be implemented at the network device 110 as shown in FIG. 1.

At block 910, the network device 110 transmits a configuration to a terminal device (for example, the terminal device 120 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device 110.

At block 920, in response to a beam failure being detected on a cell in the group of cells, the network device 110 receives a beam failure recovery request from the terminal device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new/candidate beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a first set of RSs for new/candidate bear identification, and the second subset of cells may be configured with a second set of RSs for beam failure detection and a second set of RSs for new/candidate beam identification.

In some embodiments, in response to a beam failure being detected based on the first set of RSs, the network device 110 may receive a first beam failure recovery request from the terminal device, where the first beam failure recovery request at least comprises an indication of the first TRP or the first subset of cells. In response to a beam failure being detected based on the second set of RSs for beam failure detection, the network device 110 may receive a second beam failure recovery request from the terminal device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

In some embodiments, a terminal device comprises circuitry configured to: receive a configuration from a network device, wherein the configuration indicates that each of a group of cells serving the terminal device is associated with at least one of a plurality of transmission and reception points (TRPs) coupled with the network device; and in response to a beam failure being detected on a cell in the group of cells, transmit a beam failure recovery request to the network device, wherein the beam failure recovery request comprises TRP information related to the beam failure detected on the cell.

In some embodiments, each of the plurality of TRPs is represented by at least one of the following: a control resource set (CORESET) pool index; a CORESET group identifier; an identifier of a set of reference signals (RSs) for beam failure detection; an identifier of a set of RSs for new/candidate beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a first set of RSs for new/candidate beam identification, and the second subset of cells are configured with a second set of RSs for beam failure detection and a second set of RSs for new/candidate beam identification.

In some embodiments, the terminal device comprises circuitry configured to: in response to a beam failure being detected based on the first set of RSs, transmit a first beam failure recovery request to the network device, wherein the first beam failure recovery request at least comprises an indication of the first TRP or the first subset of cells; and in response to a beam failure being detected based on the second set of RSs for beam failure detection, transmit a second beam failure recovery request to the network device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

In some embodiments, a network device comprises circuitry configured to: transmit a configuration from to a terminal device, wherein the configuration indicates that each of a group of cells serving the terminal device is associated with at least one of a plurality of transmission and reception points (TRPs) coupled with the network device; and in response to a beam failure being detected on a cell in the group of cells, receive a beam failure recovery request from the terminal device, wherein the beam failure recovery request comprises TRP information related to the beam failure detected on the cell.

In some embodiments, each of the plurality of TRPs is represented by at least one of the following: a control resource set (CORESET) pool index; a CORESET group identifier; an identifier of a set of reference signals (RSs) for beam failure detection; an identifier of a set of RSs for new/candidate beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a first set of RSs for new/candidate beam identification, and the second subset of cells are configured with a second set of RSs for beam failure detection and a second set of RSs for new/candidate beam identification.

In some embodiments, the network device comprises circuitry configured to: in response to a beam failure being detected based on the first set of RSs, receive a first beam failure recovery request from the terminal device, wherein the first beam failure recovery request at least comprises an indication of the first TRP or the first subset of cells; and in response to a beam failure being detected based on the second set of RSs for beam failure detection, receive a second beam failure recovery request from the terminal device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

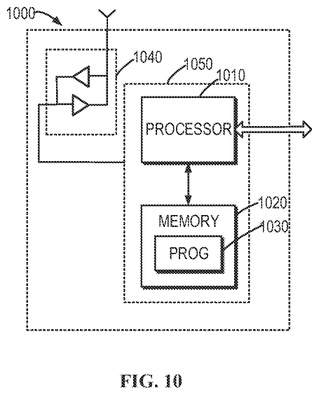

FIG. 10 is a simplified block diagram of a device 1000 that is suitable for implementing embodiments of the present disclosure. The device 1000 can be considered as a further example implementation of the network device 110, the TRP 130 and/or the terminal device 120 as shown in FIG. 1. Accordingly, the device 1000 can be implemented at or as at least a part of the network device 110, the TRP 130 and/or the terminal device 120 as shown in FIG. 1.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs. SI interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIG. 1 to FIG. 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-55. (canceled)

56. A method, performed by a terminal device, the method comprising:
receiving, from a network device, a first set of reference signals (RSs) and a second set of RSs for a serving cell for beam failure detection;
performing a beam failure recovery (BFR) procedure, in a case where a beam failure is detected on at least one of the first set of RSs or the second set of RSs; and
performing a random access procedure on the serving cell for beam failure recovery, in a case where a first BFR is triggered for the first set of RSs, a second BFR is triggered for the second set of RSs, and the BFR procedure is not successfully completed for any of the first set of RSs and the second set of RSs,
wherein a procedure other than the random access procedure is performed for beam failure recovery, in a case where a BFR is triggered for only one of the first set of RSs and the second set of RSs.

57. The method of claim 56, wherein the beam failure is detected in a case where:
a beam failure indication for the at least one of the first set of RSs or the second set of RSs is received from lower layers,
a beam failure indication counter for the at least one of the first set of RSs or the second set of RSs is incremented by 1, and
the beam failure indication counter is equal to or larger than a maximum beam failure counter for the at least one of the first set of RSs or the second set of RSs.

58. The method of claim 56, wherein the BFR procedure comprises at least one of:
triggering a BFR for the first set of RSs or the second set of RSs; or
transmitting a BFR medium access control (MAC) control element (CE) containing BFR information for the serving cell.

59. The method of claim 56, the method further comprising:
in a case where the serving cell is a secondary cell (SCell) and the SCell is deactivated,
setting a beam failure indication counter to 0, and
considering the first beam failure recovery procedure and the second beam failure recovery procedure successfully completed and cancelling all the triggered BFRs for the serving cell.

60. The method of claim 59, wherein
the beam failure indication counter is associated with a first beam failure indication counter for the first set of RSs and a second beam failure indication counter for the second set of RSs.

61. A method, performed by a network device, the method comprising:
transmitting, to a terminal device, a first set of reference signals (RSs) and a second set of RSs for a serving cell for beam failure detection;
performing a beam failure recovery (BFR) procedure, in a case where a beam failure is on at least one of the first set of RSs or the second set of RSs; and
performing a random access procedure on the serving cell for beam failure recovery, in a case where a first BFR is triggered for the first set of RSs, a second BFR is triggered for the second set of RSs, and a BFR procedure is not successfully completed for any of the first set of RSs and the second set of RSs,
wherein a procedure other than the random access procedure is performed for beam failure recovery, in a case where a BFR is triggered for only one of the first set of RSs and the second set of RSs.

62. The method of claim 61, wherein the beam failure is detected in a case where:
a beam failure indication counter is equal to or larger than a maximum beam failure counter for the at least one of the first set of RSs or the second set of RSs.

63. The method of claim 61, wherein the BFR procedure comprises at least one of:
receiving a BRF trigger for the first set of RSs or the second set of RSs; or
receiving a BFR medium access control (MAC) control element (CE) containing BFR information for the serving cell.

64. The method of claim 61, the method further comprising:
in a case where the serving cell is a secondary cell (SCell) and the SCell is deactivated,
a beam failure indication counter is set to 0, and
the first beam failure recovery procedure and the second beam failure recovery procedure are considered to be successfully completed and all the triggered BFRs for the serving cell are cancelled.

65. The method of claim 64, wherein
the beam failure indication counter is associated with a first beam failure indication counter for the first set of RSs and a second beam failure indication counter for the second set of RSs.

66. A terminal device, comprising a processor configured to cause the terminal device to:
receive, from a network device, a first set of reference signals (RSs) and a second set of RSs for a serving cell for beam failure detection;
perform a beam failure recovery (BFR) procedure, in a case where a beam failure is detected on at least one of the first set of RSs or the second set of RSs; and
perform a random access procedure on the serving cell for beam failure recovery, in a case where a first BFR is triggered for the first set of RSs, a second BFR is triggered for the second set of RSs, and the BFR procedure is not successfully completed for any of the first set of RSs and the second set of RSs,
wherein a procedure other than the random access procedure is performed for beam failure recovery, in a case where a BFR is triggered for only one of the first set of RSs and the second set of RSs.

67. The terminal device of claim 66, wherein the beam failure is detected in a case where:
a beam failure indication for the at least one of the first set of RSs or the second set of RSs is received from lower layers,
a beam failure indication counter for the at least one of the first set of RSs or the second set of RSs is incremented by 1, and
the beam failure indication counter is equal to or larger than a maximum beam failure counter for the at least one of the first set of RSs or the second set of RSs.

68. The terminal device of claim 66, wherein the BFR procedure comprises at least one of:
triggering a BFR for the first set of RSs or the second set of RSs; or
transmitting a BFR medium access control (MAC) control element (CE) containing BFR information for the serving cell.

69. The terminal device of claim 66, the processor further configured to cause the terminal device to:
in a case where the serving cell is a secondary cell (SCell) and the SCell is deactivated,
set a beam failure indication counter to 0, and
consider the first beam failure recovery procedure and the second beam failure recovery procedure successfully completed and cancelling all the triggered BFRs for the serving cell.

70. The terminal device of claim 69, wherein
the beam failure indication counter is associated with a first beam failure indication counter for the first set of RSs and a second beam failure indication counter for the second set of RSs.
